(19) United States
(12) Patent Application Publication
(10) Pub. No.: US 2022/0298377 A1
(43) Pub. Date: Sep. 22, 2022

(54) ENHANCED POLYMER PROPERTIES FOR COATING AND/OR FILM

(71) Applicant: DUVALTEX INC., Saint-Georges (CA)

(72) Inventors: Hamid BENADDI, Granby (CA); Martin BOURQUE, St-Georges (CA); Anne DALLAIRE, Sainte-Marie (CA)

(21) Appl. No.: 17/697,255

(22) Filed: Mar. 17, 2022

Related U.S. Application Data
(60) Provisional application No. 63/162,181, filed on Mar. 17, 2021.

(51) Int. Cl. C09D 175/04; C08J 5/18; C09D 133/08; G01N 21/78; B29C 41/00; B29C 41/46

(52) U.S. Cl. CPC C09D 175/04; C08J 5/18; C09D 133/08; G01N 21/78; B29C 41/003; B29C 41/46; C08J 2375/04; C08J 2333/08; C08J 2403/00; B29K 2075/00

(57) ABSTRACT

There is provided a polyurethane and/or polyacrylic coating and/or film that includes a polyurethane and/or polyacrylic layer; a biodegradation-inducing additive in the polyurethane and/or polyacrylic layer at a concentration of between 0.1 to 6% by weight. This polyurethane and/or polyacrylic coating and/or film is biodegradable.

### CROSS-REFERENCE TO RELATED APPLICATION

The present application claims the priority of U.S. Patent Application No. 63/162,181, filed on Mar. 17, 2021, and incorporated herein by reference.

### TECHNICAL FIELD

The present disclosure generally relates to the field of coatings/films such as polyacrylic and polyurethane coatings and/or films.

### BACKGROUND

To render a textile material waterproof or hydrostatic water resistant, polyacrylic and polyurethane polymers are applied on the external surface and/or the internal surface and/or in between two layers of the textile material. These coatings or membranes are common in outdoor wear setting as well as others, for example, bags, tents, garments, upholstery, seating, chairs and the like. The textile industry has produced and is producing an alarming amount of these non biodegradable coatings and films. The biodegradation of synthetic textiles in landfills or oceans can take up to a hundred years or more. There is therefore a need for improving the biodegradability and sustainability of textile polyacrylic and polyurethane coatings.

### SUMMARY

In one aspect, there is provided a polyurethane and/or polyacrylic coating and/or film including: a polyurethane and/or polyacrylic layer; a biodegradation-inducing additive in the polyurethane and/or polyacrylic layer at a concentration of between 0.1 to 6% by weight; and the polyurethane and/or polyacrylic coating and/or film is biodegradable. In some embodiments, the polyurethane and/or polyacrylic coating and/or film has a level of biodegradability defined as having at least 90% of the polyacrylic and/or polyurethane contained in the coating and/or film is degraded in less than 4 years as per ASTM D5511. In some embodiments, the coating and/or film is hydrophilic, hydrophobic or microporous. In some embodiments, the coating and/or film has a Moisture Vapor Transmission Rate (MVTR) of from 50 to 10000 g/m²/24 h according to ASTM E96 BW or from 10 to 3000 g/m²/24 h according to ASTM E96 B. In some embodiments, the biodegradation-inducing additive is detectable by a colorimetric assay, the biodegradation-inducing additive configured to change color when used as the coating and/or the film and exposed to a colorimetric agent, a color change associated with the biodegradation-inducing additive being within a given spectrum range indicating the presence or absence of the biodegradation-inducing additive in the coating and/or the film. In some embodiments, the polyurethane is an aliphatic polyurethane or an aromatic polyurethane. In some embodiments, the coating and/or the film has a thickness of between 0.1 and 3.0 mm. In some embodiments, the concentration of the biodegradation-inducing additive is between 0.5 and 6 wt. %. In some embodiments, the concentration of the biodegradation-inducing additive is between 1 and 3 wt. %. In some embodiments, the biodegradation-inducing additive is selected from polysaccharide, polylactic acid, polycaprolactone, polybutylene succinate, polybutylene terephthalate-coadipate, furanone, carboxylic acids, or glutaric acids. In some embodiments, the biodegradation-inducing agent is a starch-based polymer.

In a further aspect, there is provided a method of fabricating a biodegradable polyurethane and/or polyacrylic coating and/or film, the method includes: obtaining a substrate; depositing a monomer layer having in weight percent between 20 to 99.9% of monomers of polyurethane and/or polyacrylic and between 0.1 to 6.0% by weight of a biodegradation-inducing additive on the substrate; and drying and or curing at a temperature of between 200 and 350 F to obtain the biodegradable polyurethane and/or polyacrylic coating and/or film on the substrate. In some embodiments, the depositing the monomer layer includes depositing a liquid phase comprising 20 to 60 wt. % of the monomers of polyurethane and/or polyacrylic. In some embodiments, the depositing of the liquid phase comprises depositing a liquid selected from water, isopropanol, toluene, methyl ethyl ketone, acetone and combinations thereof. In some embodiments, the depositing of the liquid phase comprises depositing an aqueous phase. In some embodiments, the depositing is a direct deposition, a knife coating, a padding, a transfer coating, an extrusion or a doctor-blading. In some embodiments, the method further includes sacrificing the substrate to obtain the polyurethane and/or polyacrylic film. In some embodiments, the method further includes after the drying or the curing, removing, dissolving, disintegrating or detaching the sacrificial substrate.

In still a further aspect, there is provided a method of detecting whether a biodegradation-inducing additive is present in a polyurethane and/or polyacrylic coating and/or film, the method includes: contacting a colorimetric agent with the coating and/or the film; heating the coating and/or the film in an aqueous phase; and observing a change of color in the aqueous solution, a color change within a given spectrum range indicating the presence or absence of the biodegradation-inducing additive in the coating and/or the film. In some embodiments, the contacting of the colorimetric agent includes contacting an iodine based colorimetric agent. In some embodiments, the heating is performed at 100 to 150° C.

Many further features and combinations thereof concerning the present improvements will appear to those skilled in the art following a reading of the instant disclosure.

### DESCRIPTION OF THE DRAWINGS

FIG. 1 is a flow chart illustrating a method for fabricating a biodegradable polyacrylic or polyurethane coating in accordance with the present disclosure.

FIG. 2 is a graph showing the biodegradation (in percentage) in function of time (days) of two controls (negative and positive), an acrylic backing without a biodegradation additive, and two samples in accordance with the present disclosure.

FIG. 3 is a photograph showing a film with the biodegradable polyacrylic or polyurethane coating, stained with a colorimetric indicator for determining the presence of the biodegradation-inducing additive.

FIG. 4 is a photograph showing the absence of staining on an aqueous phase in which a negative control polyacrylic film without biodegradation-inducing additive was exposed to a colorimetric indicator.

FIG. 5 is a photograph showing the staining of an aqueous phase in which a polyacrylic film with biodegradation-inducing additive was exposed to a colorimetric indicator.

FIG. 6 is a photograph showing a replicate experiment of FIG. 5.

### DETAILED DESCRIPTION

The present disclosure concerns biodegradable polyacrylic and/or polyurethane textile coatings and/or films. The term “polyacrylic” as used herein refers to a polymer produced from an acrylic monomer. The polyacrylic polymer formed may be a simple polyacrylic (e.g. initial monomer of CH₂—CH—CN), a polyacrylic acid, and/or a polyacrylate. The polyurethane polymer as used herein refers to a polymer comprising the urethane group R—NH—CO—O—R at the monomer level. In one embodiments, the polymers of the present disclosure are thermoplastic elastomers. In one embodiment, the coatings and/or films including polyurethane and/or polyacrylic are free of any toxic components as they are intended as a textile that may come into contact with human skin. There are different types of polyurethane polymers such as aliphatic polyurethane and aromatic polyurethane. Accordingly, in one embodiment, the polyurethane is aliphatic or aromatic. In some embodiments, aliphatic polyurethanes may have a better biodegradability than aromatic polyurethanes. In some embodiments, the polyurethane and the polyacrylic have a molecular weight of 10,000 Da, 15,000 Da, or more. The polyurethane and polyacrylic polymers according to the present disclosure are not sufficiently biodegradable on their own, however when produced into a textile coating and/or film with a biodegradable-inducing additive, the resulting coating and/or film is biodegradable. Therefore, the present disclosure advantageously provides the properties of polyurethane and/or polyacrylic while overcoming the environmental concerns by rendering the resulting coating and/or film biodegradable. The properties of polyurethane and/or polyacrylic according to the present disclosure can include any one of mechanical strength (e.g. for outdoor applications such as hammocks and tents), water and weather resistance, chemical resistance (e.g. N,N-Diethyl-meta-toluamide, chlore, and ozone), environmental resistance, durability, softness, and breathability.

The biodegradable polyurethane and/or polyacrylic coating and/or film according to the present disclosure has at least one of polyurethane and polyacrylic polymer. For example, the coating and/or film comprises at least 80%, at least 85%, at least 90% by weight of polyurethane. In another example, the coating and/or film comprises at least at least 80%, at least 85%, at least 90% by weight of polyacrylic. Polyurethane and polyacrylic may be mixed depending on the desired application of the coating and/or film. A mixture of both may be desirable from a cost perspective. However, because of their different physico-chemical properties, polyurethane and polyacrylic acid may also be separated into different products. Furthermore, the biodegradable polyurethane and/or polyacrylic coating and/or film includes a biodegradation-inducing additive. In one embodiment, the coating and/or film comprises between 0.1 and 6.0, between 0.5 and 6.0, between 0.5 and 3.0, between 1 and 3, between 0.5 and 2.0, between 0.8 and 2.0, between 1.0 and 2.0, or between 1.0 to 1.5 of the biodegradation-inducing additive in weight percent relative to the total weight of the coating and/or film composition. In some embodiments, the coating and/or film has a thickness of between 0.1 and 3.0 mm, between 0.1 and 2.0 mm, between 0.3 and 1.5 mm or between 0.5 and 1.0 mm. In some embodiments, the polyurethane and/or polyacrylic coating and/or film is hydrophilic, hydrophobic or microporous. The coating and/or film can be hydrophobic and non-breathable which is particularly suited, for example, for seats, sofas, but also breathable suitable for jackets, bivy bags, gloves, moisture barrier, coats and the like. In some embodiments, polyurethane and/or polyacrylic coating and/or film has a Moisture Vapor Transmission Rate (MVTR) from 50 to up to 10,000 g/m²/24 h according to ASTM E96 BW or from 10 to 3000 g/m²/24 h according to ASTM E96 B.

The biodegradable additive, a.k.a., a biodegradation-inducing additive, is an additive incorporated in the polyurethane and/or polyacrylic to render the resulting coating and/or film biodegradable. Thus, for simplicity, the term “biodegradable additive” is used herein and refers to any additive that can render a polyurethane and/or polyacrylic polymer biodegradable. The biodegradable additive can be an agent that promotes the microbial degradation of polyurethane and/or polyacrylic (e.g. recruiting microorganisms or facilitating enzymatic reactions), and/or that promotes the chemical degradation of polyurethane and/or polyacrylic (e.g. thermal oxidation, photo-oxidation, or hydrolysis). The biodegradable additive may be embedded in the structure of the polyurethane and/or polyacrylic and dispersed such that many nuclei of degradation can occur, thereby improving the rate of degradation of the polyurethane and/or polyacrylic. To be absorbed and metabolized by microorganisms the polyurethane and/or polyacrylic have to be broken down into smaller organic molecules (oligomers, dimers, and/or monomers). In one example, reactions that break down the polyurethane and/or polyacrylic include hydrolysis and oxidation. In one embodiment, instead of or in addition to being degraded by environmental factors, such as sunlight (photo degradation) or heat (thermal degradation), biodegradable additives can promote, facilitate, or enhance microbial degradation which can be by direct or indirect attack on the polyurethane and/or polyacrylic. In one embodiment, the microbial enzymes involved in polyurethane and/or polyacrylic biodegradation include but are not limited to lipase, proteinase K, pronase, hydrogenase and the like.

In one embodiment, the polyurethane and/or polyacrylic is degraded into small organic molecules by hydrolysis and/or oxidation that are metabolized by microorganisms such as bacteria to turn the polyurethane and/or polyacrylic into carbon dioxide (CO₂), methane (CH₄), water (H₂O), and metabolic biomass. Thus, biodegradation can be mediated by organisms that break down and convert polyurethane and/or polyacrylic into sustainable products. In biological systems, many factors are at play including but not limited to external mechanical forces, moisture level, humidity, temperature, solar radiation, enzyme activities and other biotic interactions, which can all influence the rate of the microbial biodegradation. More generally, the environmental conditions, which also include a multitude of variable factors, play a major role in determining the rate and efficiency of the biodegradation.

In one embodiment, the biodegradable additive is selected from transition metals, calcium carbonate, chemo attractant/chemo taxi agents, acids, and/or a biodegradable polymer. The additive can be a composition of elements that may not impart biodegradability on their own but combine to achieve the effect of promoting biodegradability. Biodegradable polymers promote the biodegradation of the polyurethane and/or polyacrylic by degrading first thereby creating a porous structure which increases the surface area and reduces the structural stability therefore promoting biodegradation. Examples of additives include but are not limited to starch-based polymers, polysaccharides, polysaccharide copolymers, polylactic acid, polycaprolactone, polybutylene succinate, polybutylene terephthalate-coadipate, furanone, glutaric acids, or carboxylic acids.

The term “biodegradable” as used herein with respect to the coating and/or film of the present disclosure can be defined as biodegrading at least 90% of the polyacrylic and/or polyurethane or mixture thereof contained in the coating and/or film in less than 4 years, for example according to ASTM D5511 as explained below. In one embodiment, at least 90% of the polyacrylic and/or polyurethane contained in the coating and/or film degrades in less than 3 years, for example according to ASTM D5511 as explained below. In one embodiment, at least 20% of the polyurethane and/or polyacrylic contained in the coating and/or film degrade in less than a year. In one embodiment, the coating and/or film containing the biodegradable additive and the polyacrylic and/or polyurethane achieves a biodegradability of at least 20% after 320 days and follows a biodegradation curve to achieve 90% degradation after 4 years, preferably 3 years according to the ASTM D5511 standard test method for determining anaerobic biodegradation of plastic materials under high-solids anaerobic-digestion conditions. When studying the biodegradability of a textile, the molecular composition of the precursors, intermediates and final products can be measured using as gel permeation chromatography, or more preferably a gradient analysis of polymer blends. In one example, the biodegradability of the textile coating and/or film can be measured, defined, or determined by methods specified in standard test protocols ASTM D6691, ASTM D5210, and/or ASTM D5511, developed and published by the American Society for Testing and Materials. ASTM D6691 is the Standard Test Method for Determining Aerobic Biodegradation of Plastic Materials in the Marine Environment by a Defined Microbial Consortium or Natural Sea Water Inoculum, ASTM D5210 is the Test Method for Determining the Anaerobic Biodegradation of Plastic Materials in the Presence of Municipal Sewage Sludge, and ASTM D5511 is the Standard Test Method for Determining Anaerobic Biodegradation of Plastic Materials Under High-Solids Anaerobic-Digestion Condition. However, ASTM tests are not the only way to define the biodegradability of a textile and other suitable measurements may be used to evaluate the biodegradability of the textiles according to the present disclosure. Other standard tests include but are not limited to those by the Organisation for Economic Co-operations and Development (OECD), or the International Organization for Standardization (ISO).

In some embodiments, the polyurethane and/or polyacrylic coating and/or film comprises the biodegradation-inducing additive which is detectable by a colorimetric assay. The biodegradation-inducing additive can be configured to change color when used as the coating and/or the film is exposed to a colorimetric agent. If a color change associated with the biodegradation-inducing additive being is within a given spectrum range that indicates the presence or absence of the biodegradation-inducing additive in the coating and/or the film. The colorimetric agent can be an iodine based agent.

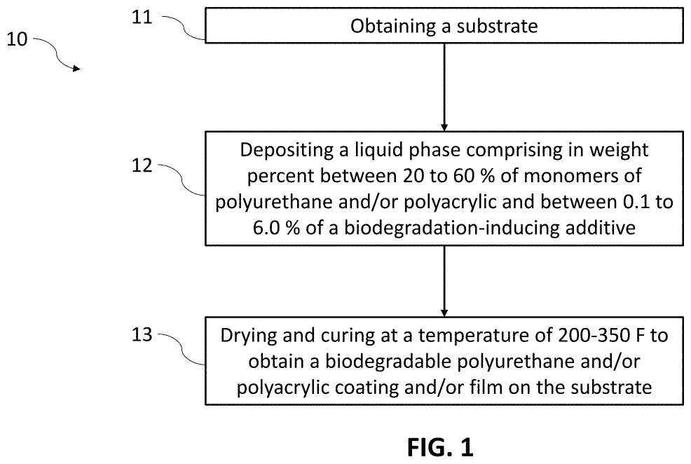

Making reference to FIG. 1, there is provided a method 10, of fabricating the textile coating and/or film, a.k.a. the biodegradable polyurethane and/or polyacrylic coating according to the present disclosure. According to 11, a substrate is provided or obtained. The substrate can be a textile substrate on which a biodegradable coating will form or a sacrificial substrate on which a film will form. The sacrificial substrate may be any substrate suitable to be used as a sacrificial substrate for polyurethane and/or polyacrylic films. In one embodiment, the textile substrate includes fibers, filaments, yarns, membranes or fabrics. The textile substrate according to the present disclosure may be any suitable textile substrate that can be coated with polyurethane and/or polyacrylic. The fibers, filaments, yarns, and fabrics may be in knit, woven or non-woven forms. The term “non-woven” may be defined as a textile structure manufactured using mechanical, chemical, thermal, solvent methods, or combinations thereof to bond and/or interlock fibers. Many natural or synthetic fibers can be manufactured into yarns and threads, these include for example wool, flax, cotton, hemp, linen, nylon, silk, and polyester. Cotton and polyester are among the most common fibers in the textile industry that produce yarns. In some embodiments, the textile material of the present disclosure, with polyester, can include at least a portion of recycled natural and/or synthetic fibers, filaments, yarns, fabrics, and precursor forms. In some embodiments, the textile substrate is biodegradable, therefore the combination of the coating and the substrate is biodegradable rendering applications thereof advantageously environmentally friendly in contrast to coatings and/or substrates that are not biodegradable. For example, the textile substrate can be a natural polymer that has inherently has a biodegradation capacity or is a synthetic polymer that is rendered biodegradable.

According to 12, a liquid phase is deposited onto the substrate, the liquid phase comprises in weight percent between 20 to 60% of monomers of polyurethane and/or polyacrylic and between 0.1 and 6.0% of biodegradation-inducing additive. In one embodiment, the liquid phase comprises between 20 to 60% by weight of polyurethane monomers. In one embodiment the liquid phase comprises between 20 to 60% by weight of polyacrylic monomers. In some embodiments, the liquid phase comprises between 25 and 55, between 30 to 50 or between 40 to 50% by weight of polymers of polyurethane and/or polyacrylic. However, in some embodiments, a monomer layer comprising or consisting of between 20 to 99.9% of monomers and 0.1 to 6% of the biodegradation-inducing additive can be deposited. This layer may or may not be a liquid phase. Regarding the biodegradable additive, in some embodiments the liquid phase comprises between 0.1 and 3.0, between 0.25 and 2.5, between 0.5 and 2.0, between 1.0 and 2.0, or between 1.5 and 2.0. in weight percent of the biodegradable additive. The liquid phase can be any suitable liquid that can produce a solution or a suspension with the biodegradable additive and the polyurethane and/or polyacrylic. In one example, the liquid phase includes water, isopropanol, toluene, methyl ethyl ketone, acetone and combinations thereof. In some embodiments, when a polyurethane coating and/or film is produced, the liquid phase is preferably an aqueous liquid phase but other solvents may be used. The deposition of the liquid phase onto the substrate can be performed, for example, by direct deposition, knife coating, padding or doctor-blading. Knife coating is performed by a stationary knife and a reservoir comprising the liquid phase which is continuously deposited between the web and the blade of the knife.

If a textile substrate is used, the deposition of the liquid phase can be applied at various times during the production of the textile substrate or after the textile substrate is produced. For example, the liquid phase can be deposited using knife coating, padding, transfer coating, direct coating, extrusion, doctor-blading or direct deposition. In one example, the transfer coating or direct coating is performed on a paper substrate. In another example, the liquid phase can be deposited on a release paper (one layer or multilayer).

According to 13, the liquid phase is dried and cured at a temperature of 200 to 350 F for a period of time sufficient to cure the polyurethane and/or polyacrylic (e.g. 0.3-2 or 2-3 minutes) and obtain the biodegradable polyurethane and/or polyacrylic coating and/or film on the substrate. To separate the film from the sacrificial substrate, the sacrificial substrate can be simply removed, dissolved, disintegrated, or detached from the deposited polyurethane and/or polyacrylic by any suitable chemical or physical means. In one embodiment, the temperature is between 220 to 350 F, between 220 to 340 F, between 230 to 330 F, or between 250 to 330 F. In one embodiment, the temperature is maintained for 1-2 minutes to allow curing. Thus, any suitable oven may be used as long as the conditions provided herein can be achieved. The curing of the liquid phase results in the incorporation of the biodegradable additive in the polymeric matrix of polyurethane and/or polyacrylic. In some embodiments, the biodegradable additive is physically contained within the polymeric matrix and does not have any chemical bonds between the biodegradable additive and the polyurethane and/or the polyacrylic acid.

Therefore, as a variant, the present disclosure disclose a polyurethane coating or a polyurethane film that may have a polyurethane layer and a biodegradation-inducing additive in the polyurethane at a concentration of between 0.1 to 6% by weight, though the additive may be at other concentrations. As a result, the polyurethane coating or a polyurethane film is biodegradable according to some standards.

As another variant, the present disclosure disclose a polyacrylic coating or a polyacrylic film that may have a polyacrylic layer and a biodegradation-inducing additive in the polyacrylic at a concentration of between 0.1 to 6% by weight, though the additive may be at other concentrations. As a result, the polyacrylic coating or a polyacrylic film is biodegradable according to some standards.

There is provided a method for detecting the presence of the biodegradable additive in a polyurethane and/or polyacrylic coating and/or film with a colorimetric agent such as iodine, or equivalent. The detection method is a colorimetric assay in which a change in the color (a.k.a., colour) of the colorimetric agent indicates the presence of the biodegradable additive, such as a change of color within a given spectrum. Conversely, the absence of color change, or a change of color in the wrong spectrum of colors, indicates the absence of the biodegradable additive. To determine whether the biodegradable additive is incorporated in polyurethane and/or polyacrylic coating and/or film, it is contacted with the colorimetric agent so that a color change can be observed. In some embodiments, the color can be analyzed by naked eye observation, microscopic observation or by spectrophotometry (with for example a wavelength around 615 nm to identify the presence of blue iodine). In one embodiment, the polyurethane and/or polyacrylic coating and/or film is contacted with the colorimetric agent (such as iodine) and heated in an aqueous phase to a temperature of from 100 to 150° C. (e.g. 130° C.), though the temperature may be outside of this range. The color change or absence of color change can thus be observed in the aqueous phase. If the biodegradable additive was incorporated in the polyurethane and/or polyacrylic coating and/or film it can be released into the aqueous phase and can react with the colorimetric agent to induce the change of color.

As a result from the method 10, there is produced a biodegradable polyurethane and/or polyacrylic coating and/or film on a substrate. The coating and/or film can be, for example, a synthetic leather, a moisture barrier, a barrier or a textile coating. In one embodiment, the coating and/or film comprises polyurethane that is breathable. In other embodiments, the polyurethane can be non breathable. Thus, the present method can be used in the fabrication of coats (e.g. rain coats), anoraks, outerwear, suits, active-ears, ponchos, trousers, footwear, fleece, tees, bottoms, bags (e.g. bivy bag and sleeping bags), handkerchiefs, gloves (e.g. medical gloves), glove insert, bags, backpacks, handbags, tents, mattresses, seating apparel (e.g. automotive seats or home sofas), curtains, upholstery, clothing, medical gowns, shelters, track cover, shoes, compost cover, and/or liners (e.g. hinging liner). The polyurethane and/or polyacrylic coating and/or film can also be used to make and/or enhance the biodegradability of packaging substrates (e.g. laminated substrate).

### Example 1: Biodegradation Assay

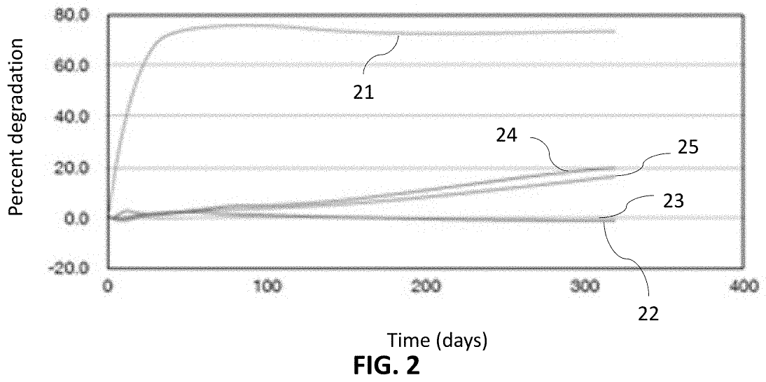

An ASTM D5511 standard test for determining anaerobic biodegradation of coated materials according to the present disclosure under high-solids anaerobic-digestion conditions was performed with a positive control (cotton) 21, a negative control (polyethylene) 22, an acrylic backing without any biodegradable additive 23, and two acrylic backing with biodegradable additive sample A 24 and sample B 25 produced according to the present disclosure. The two experimental samples A and B according to the present disclosure (24 and 25), were produced using a starch based biodegradation-inducing additive. As can be seen in FIG. 2 and Table 1 (below) samples A and B demonstrated an increased biodegradability when compared to the negative control polyethylene.

Table 1 below summarizes the results after 319 days. FIG. 2 shows the biodegradation curve of percent of biodegradation in function of time. The biodegradation curves observed in FIG. 2 for 24 and 25 can be extrapolated to a 90% degradation in 3-4 years.

TABLE 1
Summary of the results at 148 days ASTM D5511

| | Negative | Positive | acrylic | Sample | Sample |
|---|---|---|---|---|---|
| | control | control | backing | A | B |
| Cumulative | 1499.2 | 8816.6 | 1931.1 | 7971.3 | 6442.8 |
| gas volume | | | | | |
| (mL) | | | | | |
| % CH₄ | 40.5 | 37.1 | 43.9 | 49.3 | 50.6 |
| Volume CH₄ | 607.8 | 3268.1 | 847.2 | 3933.3 | 3259.6 |
| (mL) | | | | | |
| Mass CH₄ | 0.43 | 2.33 | 0.61 | 2.81 | 2.33 |
| (g) | | | | | |
| % CO₂ | 39.1 | 43.8 | 38.7 | 37.0 | 36.9 |
| Volume CO₂ | 585.7 | 3860.5 | 747.1 | 2951.4 | 2371.8 |
| (mL) | | | | | |
| Mass CO₂ | 1.15 | 7.58 | 1.47 | 5.80 | 4.66 |
| (g) | | | | | |
| Sample | 10 | 10 | 20.0 | 20.0 | 20 |
| mass (g) | | | | | |
| Theoretical | 8.6 | 4.2 | 14.3 | 14.3 | 12.4 |
| sample | | | | | |
| mass (g) | | | | | |
| Biodegraded | 0.64 | 3.82 | 0.85 | 3.69 | 3.02 |
| mass (g) | | | | | |
| % | −1.0 | 73.3 | 0.9 | 20.8 | 19.5 |
| biodegraded | | | | | |
| Adjusted | −1.4 | 100.0 | 1.2 | 28.3 | 25.3 |
| biodegraded | | | | | |
| % | | | | | |

### Example 2: Detection of the Biodegradation Agent

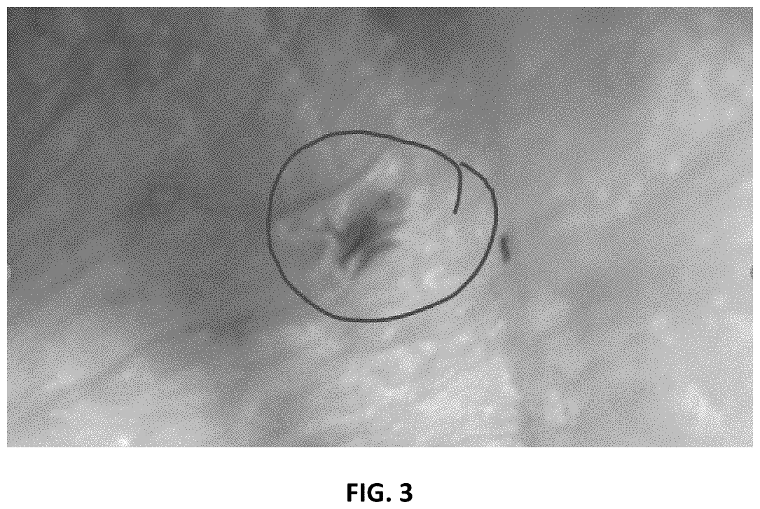

Polyacrylic films were produced according to the present disclosure with a polysaccharide as the biodegradation additive. The polysaccharides include but are not limited to starch-based polymers. A portion of the films were exposed to iodine which changed color to dark blue indicating the presence of the polysaccharide (such as starch) embedded in the films (FIG. 3).

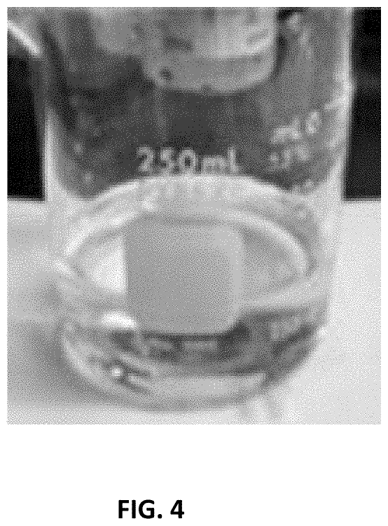

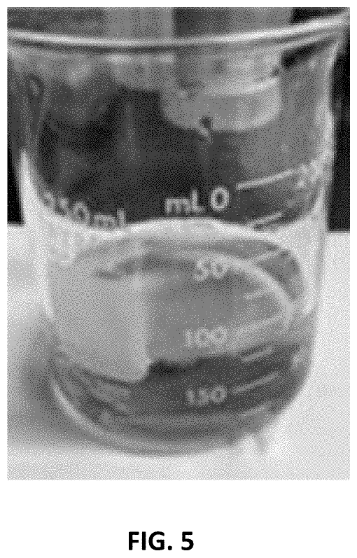

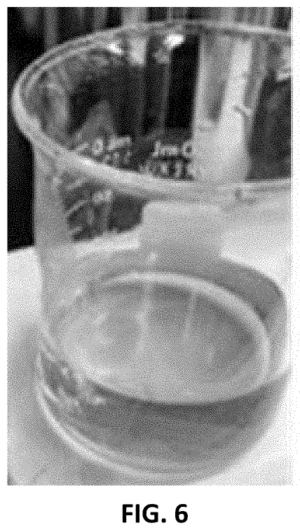

A polyacrylic film was produced without adding the biodegradation additive as a negative control and was compared to two polyurethane films produced with the biodegradation additive. The three films were then exposed to iodine in an aqueous solution that was heated to 130° C. In the negative control the aqueous solution did not show any control change (FIG. 4) whereas the two polyurethane membranes with the biodegradation additive showed a color change in the aqueous solution (FIGS. 5 and 6).

What is claimed is:

1. A polyurethane and/or polyacrylic coating and/or film comprising:
a polyurethane and/or polyacrylic layer;
a biodegradation-inducing additive in the polyurethane and/or polyacrylic layer at a concentration of between 0.1 to 6% by weight; and
wherein the polyurethane and/or polyacrylic coating and/or film is biodegradable.

2. The polyurethane and/or polyacrylic coating and/or film of claim 1, wherein the polyurethane and/or polyacrylic coating and/or film has a level of biodegradability defined as having at least 90% of the polyacrylic and/or polyurethane contained in the coating and/or film is degraded in less than 4 years as per ASTM D5511.

3. The polyurethane and/or polyacrylic coating and/or film of claim 1, wherein the coating and/or film is hydrophilic, hydrophobic or microporous.

4. The polyurethane and/or polyacrylic coating and/or film of claim 1, wherein the coating and/or film has a Moisture Vapor Transmission Rate (MVTR) of from 50 to 10000 g/m²/24 h according to ASTM E96 BW or from 10 to 3000 g/m²/24 h according to ASTM E96 B.

5. The polyurethane and/or polyacrylic coating and/or film of claim 1, wherein the biodegradation-inducing additive is detectable by a colorimetric assay, the biodegradation-inducing additive configured to change color when used as the coating and/or the film and exposed to a colorimetric agent, a color change associated with the biodegradation-inducing additive being within a given spectrum range indicating the presence or absence of the biodegradation-inducing additive in the coating and/or the film.

6. The polyurethane and/or polyacrylic coating and/or film of claim 1, wherein the polyurethane is an aliphatic polyurethane or an aromatic polyurethane.

7. The polyurethane and/or polyacrylic coating and/or film of claim 1, wherein the coating and/or the film has a thickness of between 0.1 and 3.0 mm.

8. The polyurethane and/or polyacrylic coating and/or film of claim 1, wherein the concentration of the biodegradation-inducing additive is between 0.5 and 6 wt. %.

9. The polyurethane and/or polyacrylic coating and/or film of claim 1, wherein the concentration of the biodegradation-inducing additive is between 1 and 3 wt. %.

10. The polyurethane and/or polyacrylic coating and/or film of claim 1, wherein the biodegradation-inducing additive is selected from polysaccharide, polylactic acid, polycaprolactone, polybutylene succinate, polybutylene terephthalate-coadipate, furanone, carboxylic acids, or glutaric acids.

11. The polyurethane and/or polyacrylic coating and/or film of claim 1, wherein the biodegradation-inducing agent is a starch-based polymer.

12. A method of fabricating a biodegradable polyurethane and/or polyacrylic coating and/or film, comprising:
obtaining a substrate;
depositing a monomer layer having in weight percent between 20 to 99.9% of monomers of polyurethane and/or polyacrylic and between 0.1 to 6.0% by weight of a biodegradation-inducing additive on the substrate; and
drying and or curing at a temperature of between 200 and 350 F to obtain the biodegradable polyurethane and/or polyacrylic coating and/or film on the substrate.

13. The method of claim 12, wherein the depositing the monomer layer comprises depositing a liquid phase comprising 20 to 60 wt. % of the monomers of polyurethane and/or polyacrylic.

14. The method of claim 12, wherein the depositing of the liquid phase comprises depositing a liquid selected from water, isopropanol, toluene, methyl ethyl ketone, acetone and combinations thereof.

15. The method of claim 12, wherein the depositing of the liquid phase comprises depositing an aqueous phase.

16. The method of claim 12, wherein the depositing is a direct deposition, a knife coating, a padding, a transfer coating, an extrusion or a doctor-blading.

17. The method of claim 12, further comprising sacrificing the substrate to obtain the polyurethane and/or polyacrylic film.

18. The method of claim 12, further comprising, after the drying or the curing, removing, dissolving, disintegrating or detaching the sacrificial substrate.

19. A method of detecting whether a biodegradation-inducing additive is present in a polyurethane and/or polyacrylic coating and/or film, the method comprising:
contacting a colorimetric agent with the coating and/or the film;
heating the coating and/or the film in an aqueous phase; and
observing a change of color in the aqueous solution, a color change within a given spectrum range indicating the presence or absence of the biodegradation-inducing additive in the coating and/or the film.

20. The method of claim 19, wherein the contacting of the colorimetric agent comprises contacting an iodine based colorimetric agent.
